(19) United States
(12) Patent Application Publication
(10) Pub. No.: US 2025/0327345 A1
(43) Pub. Date: Oct. 23, 2025

(54) BOOSTERLESS ELECTRONIC LATCH CIRCUIT

(71) Applicant: MAGNA CLOSURES INC., Newmarket (CA)

(72) Inventor: Francesco Cumbo, Newmarket (CA)

(21) Appl. No.: 19/097,298

(22) Filed: Apr. 1, 2025

Related U.S. Application Data
(60) Provisional application No. 63/637,687, filed on Apr. 23, 2024.

(51) Int. Cl. E05B 81/86; E05B 81/06; E05B 81/14; E05B 81/56

(52) U.S. Cl. CPC E05B 81/86; E05B 81/06; E05B 81/14; E05B 81/56

(57) ABSTRACT

A latch assembly is provided and includes a backup energy source coupled to a vehicle main power source of the motor vehicle and configured to provide a motor supply voltage. The latch assembly also includes an actuation group with a power release motor that is movable to latch and unlatch the closure panel. A control unit is coupled to the actuation group and is configured to determine whether the vehicle main power source is available. The control unit is also configured to reduce a battery voltage from the vehicle main power source to the motor supply voltage supplied to the power release motor in response to the vehicle main power source being available. The control unit is additionally configured to supply the motor supply voltage from the backup energy source to the power release motor without any voltage increase in response to the vehicle main power source not being available.

### CROSS-REFERENCE TO RELATED APPLICATION

This application claims the benefit of U.S. Provisional Application Ser. No. 63/637,687, filed Apr. 23, 2024, which is incorporated herein by way of reference in its entirety.

### FIELD

The present disclosure relates generally to an electrical latch assembly for a vehicle closure member, in particular to an electronic latch assembly without a boost circuit and method of operating the electronic latch assembly.

### BACKGROUND

This section provides background information related to the present disclosure which is not necessarily prior art.

It is desirable to have electrically activated or electronic latch assemblies in motor vehicles. A common problem related to such latch assemblies is that of controlling, as it is also required by security regulations, opening and closing of the closure members secured by the latch assemblies even in case of failure of a main power supply of the vehicle, or in case of interruptions or breaking of the electrical connection between the main power supply and an electric motor in the latch assembly; this kind of situation may occur for example in case of an accident or crash involving the motor vehicle.

Therefore, the use of a backup energy source for the electronic latch has been proposed, in order to supply electrical energy to the electric motor of the latch assembly, in case of failure or interruption of the vehicle main power supply. Such backup power supplies may provide the stored electrical energy at a lower voltage than an automotive standard voltage (for example 9 V-16 V) and, thus, boost modules or circuits can be used to increase a voltage output by the backup power supply to the automotive standard voltage. Nevertheless, boost circuits or modules increase the cost and complexity of the electronic latch assembly.

Accordingly, there remains a need for improved latch assemblies and methods of operating latch assemblies that overcome such difficulties.

### SUMMARY

This section provides a general summary of the present disclosure and is not a comprehensive disclosure of its full scope or all of its features and advantages.

An object of the present disclosure is to provide a latch assembly and a method of configuring the latch assembly that address and overcome the above-noted shortcomings.

Accordingly, it is an aspect of the present disclosure to provide a latch assembly for a closure panel of a motor vehicle. The latch assembly includes a backup energy source coupled to a vehicle main power source of the motor vehicle and configured to provide a motor supply voltage. The latch assembly also includes an actuation group with a power release motor that is movable to latch and unlatch the closure panel. A control unit is coupled to the actuation group and is configured to determine whether the vehicle main power source is available. The control unit is also configured to reduce a battery voltage from the vehicle main power source to the motor supply voltage supplied to the power release motor in response to the vehicle main power source being available. The control unit is additionally configured to supply the motor supply voltage from the backup energy source to the power release motor without any voltage increase in response to the vehicle main power source not being available.

In another aspect of the disclosure, the power release motor is configured to move a pawl of the actuation group and allow a ratchet of the actuation group to rotate and release a striker attached to the motor vehicle and selectively engaged by the ratchet to latch and unlatch the closure panel. The latch assembly further includes a power release motor bridge connected to the power release motor and the control unit and configured to provide power to the power release motor. The latch assembly additionally includes a power management unit connected to the control unit and configured to manage electrical power in the latch assembly. The latch assembly also includes a bus transceiver unit connected to the control unit and configured to enable communication therebetween.

In another aspect of the disclosure, the backup energy source includes a supercapacitor unit storing electrical energy from the vehicle main power source for use by the latch assembly when the vehicle main power source is unavailable. The latch assembly further includes a battery input unit connected to the vehicle main power source of the motor vehicle and configured to receive a battery voltage. The latch assembly additionally includes a supercapacitor switch connected to the supercapacitor unit and configured to selectively couple the motor supply voltage from the supercapacitor unit to the power release motor bridge and the power management unit during an emergency operating condition different than a normal operating condition and while charging during the normal operating condition and selectively decouple the motor supply voltage from the supercapacitor unit from the power release motor bridge and the power management unit while not charging during the normal operating condition. In addition, the latch assembly includes a backup enable unit connected to the supercapacitor unit and to the supercapacitor switch and the control unit and configured to control the supercapacitor switch. The latch assembly also includes a power supply selector connected to the supercapacitor switch and the power release motor bridge and configured to select between electrical power from the vehicle main power source and the supercapacitor unit.

In another aspect of the disclosure, the latch assembly further includes a battery reading unit connected to and configured to read a battery voltage of the vehicle main power source and connected to the control unit. The latch assembly additionally includes an internal handle reading unit connected to the backup enable unit and the control unit and the power management unit and configured to determine a state of internal handles disposed inside the motor vehicle controlling the latch and unlatch of the closure panel. Furthermore, the latch assembly additionally includes an external handle reading unit connected to the backup enable unit and the control unit and the power management unit and configured to determine a state of external handles disposed on an outside of the motor vehicle controlling the latch and unlatch of the closure panel. In addition, the latch assembly includes a hall sensor reading unit connected to the control unit and the power management unit and configured to monitor operation of the latch assembly. Also, the latch assembly includes a crash line reading unit connected to the control unit and the power management unit and configured to monitor a crash line. The latch assembly also includes a light emitting diode driver unit connected to the control unit and the power management unit and configured to drive at least one light emitting diode.

In another aspect of the disclosure, the latch assembly further includes a reverse protection unit connected to battery input unit and the power supply selector and configured to protect the latch assembly from reversal of electrical polarity from the vehicle main power source. The latch assembly also includes a supercapacitor management unit connected to the control unit and the supercapacitor unit and the power supply selector and configured to manage the supercapacitor unit.

In another aspect of the disclosure, the battery voltage from the vehicle main power source is within a range of approximately 9 volts to 16 volts and the motor supply voltage from the backup energy source is within a range of approximately 5.5 volts to 7.5 volts.

According to another aspect of the disclosure, a latch assembly for a closure panel of a motor vehicle is provided. The latch assembly includes a backup energy source coupled to a vehicle main power source of the motor vehicle. The backup energy source is configured to provide a motor supply voltage during an emergency operating condition different than a normal operating condition and in which the vehicle main power source is not available. The latch assembly also includes an actuation group with a power release motor that is movable to latch and unlatch the closure panel. The power release motor is operable with the motor supply voltage from the backup energy source directly. The motor supply voltage is less than a battery voltage of the vehicle main power source output during the normal operating condition. A control unit is coupled to and configured to control the actuation group to control latching and unlatching the closure panel.

According to yet another aspect of the disclosure, a method of operating a latch assembly for a closure panel of a motor vehicle is also provided. The method includes the step of determining whether a vehicle main power source is available. The method proceeds with the step of reducing a battery voltage from the vehicle main power source to a motor supply voltage supplied to a power release motor of an actuation group movable to latch and unlatch the closure panel in response to the vehicle main power source being available. The next step of the method is supplying the motor supply voltage from a backup energy source coupled to the vehicle main power source to the power release motor without any voltage increase in response to the vehicle main power source not being available. The method also includes the step of controlling the actuation group to control latching and unlatching the closure panel.

In another aspect of the disclosure, the method further includes the step of receiving a battery voltage using a battery input unit connected to the vehicle main power source of the motor vehicle. The method additionally includes the step of storing electrical energy from the vehicle main power source for use by the latch assembly when the vehicle main power source is unavailable using a supercapacitor unit of the backup energy source. Also, the method include the step of selectively coupling the motor supply voltage from the supercapacitor unit to the power release motor bridge and the power management unit during an emergency operating condition different than a normal operating condition and while charging during the normal operating condition and selectively decoupling the motor supply voltage from the supercapacitor unit from the power release motor bridge and the power management unit while not charging during the normal operating condition using a supercapacitor switch connected to the supercapacitor unit. Furthermore, the method includes the step of controlling the supercapacitor switch using a backup enable unit connected to the supercapacitor unit and to the supercapacitor switch and the control unit. The method also includes the step of selecting between electrical power from the vehicle main power source and the supercapacitor unit using a power supply selector connected to the supercapacitor switch and the power release motor bridge.

In another aspect of the disclosure, the method further includes the step of reading a battery voltage of the vehicle main power source using a battery reading unit connected thereto and connected to the control unit. The method additionally includes the step of determining a state of internal handles disposed inside the motor vehicle controlling the latch and unlatch of the closure panel using an internal handle reading unit connected to the backup enable unit and the control unit and the power management unit. Furthermore, the method includes the step of determining a state of external handles disposed on an outside of the motor vehicle controlling the latch and unlatch of the closure panel using an external handle reading unit connected to the backup enable unit and the control unit and the power management unit. Also, the method includes the step of monitoring operation of the latch assembly using a hall sensor reading unit connected to the control unit and the power management unit. The method further includes the step of monitoring a crash line using a crash line reading unit connected to the control unit and the power management unit. The method also includes the step of driving at least one light emitting diode using a light emitting diode driver unit connected to the control unit and the power management unit.

In another aspect of the disclosure, the method further includes the step of protecting the latch assembly from reversal of electrical polarity from the vehicle main power source using a reverse protection unit connected to battery input unit and the power supply selector. The method also includes the step of managing the supercapacitor unit using a supercapacitor management unit connected to the control unit and the supercapacitor unit and the power supply selector.

According to a further another aspect of the disclosure, a latch assembly for a closure panel of a motor vehicle is provided. The match assembly includes a backup energy source coupled to a vehicle main power source of the motor vehicle and configured to provide a motor supply voltage. The latch assembly further includes an actuation group having a power release motor being movable to latch and unlatch the closure panel. The power release motor is configured to use the motor supply voltage supplied from the backup energy source without the motor supply voltage being increased with the use of a boost convertor.

In another aspect of the disclosure, the use of the motor supply voltage supplied from the backup energy source without the motor supply voltage being increased with the use of a boost convertor includes reducing a battery voltage from the vehicle main power source to the motor supply voltage supplied to the power release motor of the actuation group by controlling a pulse width modulation signal to the power release motor.

In another aspect of the disclosure, the latch assembly further includes a reverse protection unit connected to battery input unit and the power supply selector and configured to protect the latch assembly from reversal of electrical polarity from the vehicle main power source. The latch assembly also includes a supercapacitor management unit connected to the control unit and the supercapacitor unit and the power supply selector and configured to manage the supercapacitor unit.

In accordance with another aspect, a latch assembly for a closure panel of a motor vehicle includes a backup energy source coupled to a vehicle main power source of the motor vehicle and configured to provide a motor supply voltage, an actuation group having a power release motor being movable to latch and unlatch the closure panel, a normal voltage supply circuit for coupling the vehicle main power source to the power release motor during a normal operating condition, wherein the normal voltage supply circuit is configured to reduce a voltage of the vehicle main power source to match the operating rating of the power release motor, and a backup voltage supply circuit for coupling the backup energy source to the power release motor during an emergency operating condition, wherein the backup voltage supply circuit is configured to directly provide the motor supply voltage to the power release motor.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic representation of a motor vehicle with a closure panel and a latch assembly according aspects of the disclosure;

FIG. 2 is an exploded side perspective view of a part of the latch assembly of FIG. 1 according to aspects of the disclosure;

FIG. 3 is a block diagram of the electronic control circuit 10 of the latch assembly of FIG. 1 according to aspects of the disclosure;

FIG. 4 illustrates steps of a method of operating a latch assembly according to aspects of the disclosure;

FIG. 5 is a block diagram of another electronic control circuit of the latch assembly of FIG. 1 according to aspects of the disclosure; and

FIG. 5A is a block diagram of yet another electronic control circuit of the latch assembly of FIG. 1 according to aspects of the disclosure.

### DETAILED DESCRIPTION

In the following description, details are set forth to provide an understanding of the present disclosure. In some instances, certain circuits, structures and techniques have not been described or shown in detail in order not to obscure the disclosure.

In general, the present disclosure relates to a latch assembly of the type well-suited for use in many applications. The latch assembly and associated methods of configuration of this disclosure will be described in conjunction with one or more example embodiments. However, the specific example embodiments disclosed are merely provided to describe the inventive concepts, features, advantages and objectives with sufficient clarity to permit those skilled in this art to understand and practice the disclosure. Specifically, the example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

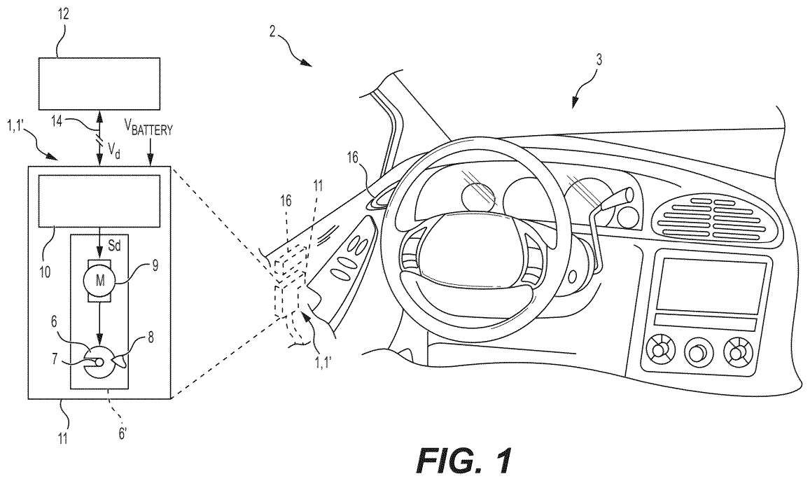

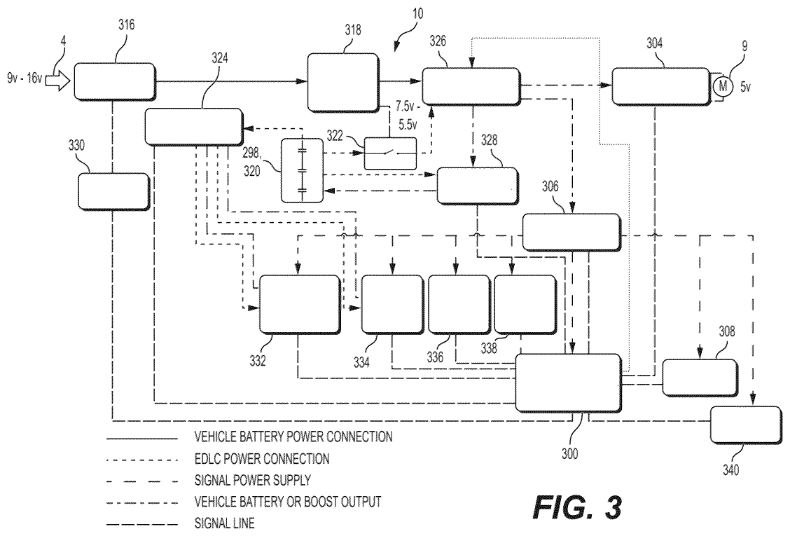

As best shown in FIG. 1, a latch assembly 1, 1′, referred to as a “Smart Latch” or e-latch, is coupled to a closure panel (e.g., side door 2) of a motor vehicle 3. However, it should be understood that the latch assembly 1, 1′ may equally be coupled to any kind of closure device or panel of the motor vehicle 3. The latch assembly 1, 1′ is electrically connected to a vehicle main power source 4 (FIG. 3) of the motor vehicle 3, for example a main battery providing illustratively a battery voltage Vbattery of 12 V, through an electrical connection element, for example a power cable (the vehicle main power source 4 may equally include a different source of electrical energy within the motor vehicle 3, for example an alternator).

The latch assembly 1, 1′ includes at least one actuation group 6′ disposed within the latch housing 11, including a latch electric motor 9 operable to control actuation of the door 2 (or in general of the closure panel to latch and unlatch the closure panel). Latch electric motor 9 is an illustrative example of a motor for driving actuation of a component of a closure member, such as a latch assembly 1, 1′. Other types of components having a motor include but are not limited to, a window regulator motor, a door presenter motor, a power actuator motor, a cinch motor, a deployable handle motor, a mirror motor, a gesture or access system, an identify authentication system (e.g. a passive keyless entry (PKE) system), a user interface such as a keypad or interface, and the like without limitation. As shown, the at least one actuation group 6′ includes a ratchet 6, which is selectively rotatable to engage a striker 7 (fixed to the body of the motor vehicle 3, for example to the so called “A pillar” or “B pillar”, in a manner not shown in detail). When the ratchet 6 is rotated into a latching position with respect to the striker 7 (i.e., a primary position of the ratchet 6), the side door 2 is in a closed operating state. A pawl 8 selectively engages the ratchet 6 to prevent it from rotating, driven by the latch electric motor 9, so as to move between an engaged position and a non-engaged position, thereby providing a power release function. An additional electrical motor, or same electrical motor may be provided to provide other latch functions other than a power release function, for example the ratchet 6 may also be driven by an electrical motor in order to cinch the door 2 relative to the motor vehicle 3, and for example the ratchet 6 may also be driven by an electrical motor in order to present the door 2 relative to the motor vehicle 3.

The latch assembly 1, 1′ further includes an electronic control circuit 10, which may be conveniently embedded and arranged in a latch housing 11 (shown schematically) with the at least one actuation group 6′ of the latch assembly 1, 1′, thus providing an integrated compact and easy-to-assemble unit.

The electronic control circuit 10 is coupled to the latch electric motor 9 of the at least one actuation group 6′ and provides driving signals Sd thereto. The electronic control circuit 10 may also be electrically coupled to a main vehicle management unit 12 (also known as main ECU or “vehicle body computer” or Body Control Module or BCM), which is configured to control general operation of the motor vehicle 3, via a data bus 14, so as to exchange signals, data, commands and/or information.

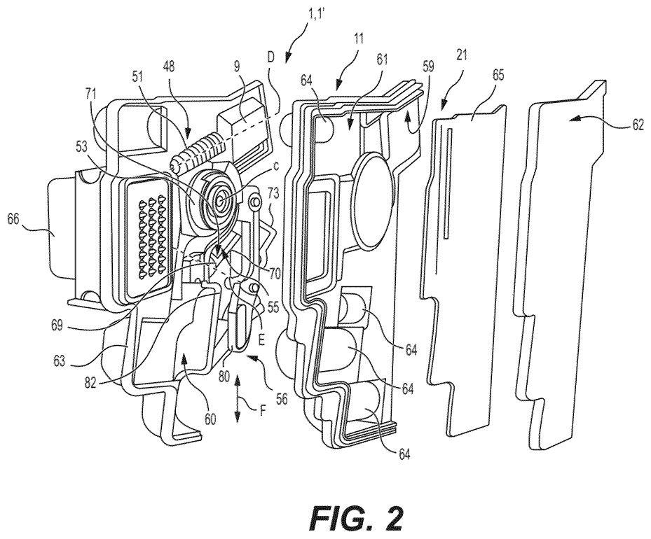

FIG. 2 illustrates an exploded side perspective view of a part of the latch assembly 1, 1′ of FIG. 1. The latch housing 11 of the latch assembly 1, 1′ internally houses, in a fluid-tight manner, latch electric motor 9, worm gear 51 and gear wheel 53; the other components of the latch assembly, e.g., sector gear 55 and actuating lever 56, are all externally carried by latch housing 11. Gear wheel 53 is fitted onto a common shaft of axis C, externally protruding, in a fluid-tight manner, from latch housing 11. In practice, worm gear 51 and gear wheel 53 define a first transmission 48 housed, in a fluid-tight manner, inside latch housing 11 and directly driven by latch electric motor 9.

The latch housing 11 has a sandwich structure and defines two distinct chambers 59, 60, one of which (chamber 59) houses, in a fluid-tight manner, latch controller 21 comprising the electronic control circuit 10 and the other one (chamber 60) houses, in a fluid-tight manner, latch electric motor 9 and transmission 48, e.g., worm gear 51 and gear wheel 53. More specifically, latch housing 11 comprises a central plate 61 and two cover elements 62, 63, arranged on opposite sides of plate 61 and peripherally coupled thereto in a fluid-tight manner to define the opposite chambers 59, 60.

Chamber 59 houses a printed circuit board 65 and a plurality of capacitors 64 connected to printed circuit board 65 and including latch controller 21 and other elements of the electronic control circuit 10. Cover element 63 delimits, with plate 61, chamber 60 and carries sector gear 55 and actuating lever 56.

Plate 61 defines a plurality of seats for capacitors 64; the connection of the capacitors 64 to the printed circuit board 65 is made for example by press-fit connectors, known per se and not shown. Cover element 62 defines a plurality of seats for latch electric motor 9, worm gear 51 and gear wheel 53, which are closed on the opposite side by plate 61. Cover element 62 also houses an electric connector 66 for connecting electronic control circuit 10 to an electrical system of the motor vehicle 3 (e.g., to the BCM 12).

Latch electric motor 9 is housed in the portion of cover element 62 defining the upper part of latch housing 11; gear wheel 53, sector gear 55 and actuating lever 56 are all arranged inferiorly with respect to latch electric motor 9. Latch electric motor 9 and worm gear 51 have an axis D orthogonal to axis C. Latch electric motor 9 and worm gear 51 are rotated in opposite directions to perform a release function and a reset function respectively for moving the pawl 8 (FIG. 1) between a ratchet released position and a ratchet holding position respectively. Gear wheel 53 is mounted for rotation about axis C and receive actuation forces from worm gear 51; in greater detail, gear wheel 53 is driven by worm gear 51.

Sector gear 55 is mounted for rotation about a fixed pin having an axis E parallel to axis C and spaced therefrom. Sector gear 55 further comprises three cam surfaces 69, 70, 71 for interacting with actuating lever 56. Cam surface 70 acts in the same direction as cam surface 69 and is adapted to cooperate with actuating lever 56 to move the latter along a release stroke. In particular, sector gear 55 is rotated by latch electric motor 9, worm gear 51 and gear wheel 53 about axis E in a primary direction to produce release of a latch, and in a secondary direction, opposite to the first direction, to obtain reset of an auxiliary ratchet to an enabling position, in which the auxiliary ratchet allows closure of the latch by slamming the door 2.

Actuating lever 56 is carried by the latch housing 11 in a displaceable manner along respective longitudinal direction F. Release and reset strokes of actuating lever 56 is defined by opposite movements of such lever 56 along the respective longitudinal direction F.

FIG. 3 is a block diagram of the electronic control circuit 10 of the latch assembly 1, 1′ for the closure panel 2 of the motor vehicle 3 shown in FIG. 1. The latch assembly 1, 1′ includes a backup energy source 298 coupled to the vehicle main power source 4 (e.g., vehicle battery) of the motor vehicle 3 and configured to provide a motor supply voltage (e.g., 9-16 Volts). According to an aspect, the backup energy source 298 is configured to provide the motor supply voltage during an emergency operating condition different than a normal operating condition and in which the vehicle main power source 4 is not available. As discussed above and referring back to FIG. 1, the latch assembly 1, 1′ includes an actuation group 6′ having a power release motor 9 movable to latch and unlatch the closure panel 2. Specifically, the power release motor 9 is configured to move the pawl 8 of the at least one actuation group 6′ and allow the ratchet 6 of the at least one actuation group 6′ to rotate and release the striker 7 attached to the motor vehicle 3 and selectively engaged by the ratchet 6 to latch and unlatch the closure panel 2. Latch assembly 1, 1′ in accordance with another illustrative embodiment may be provided with a single pawl, and also with more than one pawl, such as part of a double pawl configuration, or a double-pawl double-ratchet configuration, providing decreases in release efforts thereby requiring less output force by power release motor 9 to release the latch assembly 1, 1′. According to another aspect, the power release motor 9 is operable with the motor supply voltage (e.g., 5.5 to 7.5 Volts) from the backup energy source 298 directly, and for example directly without conversion of voltage levels, and the motor supply voltage is less than the battery voltage Vbattery (e.g., 9 to 16 Volts) of the vehicle main power source 4 output during the normal operating condition. For example, power release motor 9 may have an operating voltage rating of 5 Volts. So, according to an aspect, the power release motor 9 is configured to use the motor supply voltage supplied from the backup energy source 298 without the motor supply voltage being increased with the use of a boost convertor. In one configuration, power release motor 9 having a lower operating voltage rate, such as 5 Volts, compared to a higher power output motor having a 12 Volt operating rating, may provide an output force sufficient to release at least one pawl, and for example may provide sufficient output force to release at least two or more pawls when configured as part of a double pawl configuration, or a double-pawl double-ratchet configuration. Examples of non-single pawl latches providing reduced release efforts which may include at least two or more pawls are shown and described in U.S. Pat. No. 10,648,204 titled “Latch for a door of a motor vehicle”, in U.S. Pat. No. 12,158,029 titled “Closure latch assembly with double pawl mechanism”, in US Patent Application US20210230912 titled “Automotive latch including bearing and double pawl to facilitate release effort”, in U.S. Pat. No. 10,648,204 titled “Latch for a door of a motor vehicle”, in U.S. Pat. No. 8,596,696 titled “Vehicular latch with single notch ratchet”, and in U.S. Pat. No. 12,024,930 titled “Closure latch assembly with latch mechanism having roller pawl assembly”, the entire contents of each patent is incorporated by reference herein in their entireties.

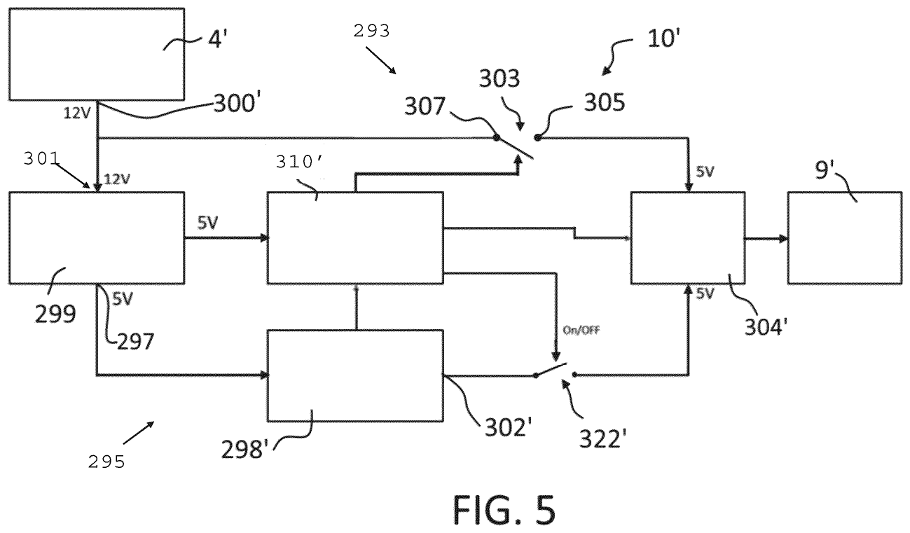

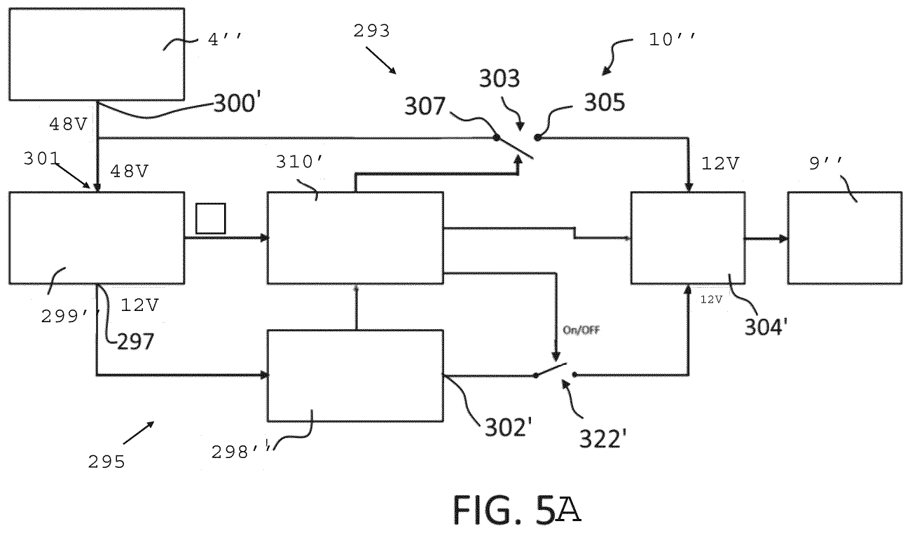

The latch assembly 1, 1′ also includes a control unit 300 (e.g., as part of the electronic control circuit 10). The control unit 300 is coupled to the at least one actuation group 6′ and is configured to control latching and unlatching the closure panel 2. More specifically, the control unit 300 is configured to determine whether the vehicle main power source 4 is available. Since a 6V voltage is used for the power release motor 9, during normal operation, the 12V battery supply Vbattery cannot directly drive the rotation of the motor 9, since it would cause the motor 9 to excessively spin possibly causing damage. Therefore, the control unit 300 is also configured to reduce the battery voltage Vbattery from the vehicle main power source 4 to the motor supply voltage supplied to the power release motor 9 in response to the vehicle main power source 4 being available. Such a reduction can, for example, include controlling a pulse width modulation (PWM) signal to the power release motor 9 using the control unit 300. In other words, the voltage to the motor 9 is controlled during the non-emergency mode using PWM (e.g., the driving signals Sd) to reduce the power supplied to the motor 9, so it operates in a usual speed range as a 12V motor would operate. For example, in accordance with another illustrative example, a series resistor, or a voltage divider circuit may be used to reduce the voltage, and thus power, supplied from vehicle main power source 4 to the motor 9 during the normal operating mode of the motor 9. For example, a pulse modulated controlled switch provided between the motor 9 and the vehicle main power source 4 may be provided to reduce the voltage of the vehicle main power source 4 (see FIG. 5 for example) and be configured to be switched on and off (e.g. with less than 100% a duty cycle) to provide a reduction in the average power delivered to the motor 9 as compared to a full (e.g. a 100% supply) and direct, supply of voltage from the vehicle main power source 4. A switch may be operated as controlled by a microcontroller for example e.g. turned ON and OFF using a duty cycle that reduces the average power supplied to the motor 9 causing a reduction in the speed of operation of the motor 9 by matching the power supply with the normal operating rating of the motor 9. The reduced power supply (e.g. average power supply) to the motor 9 having a voltage rating (e.g. 5V) mismatched with the supply source voltage (e.g. 12V) will cause the motor's 9 operating speed to also be reduced in order to provide a similar speed performance of the larger, and more costly higher voltage rated motor (e.g. 12V), being supplied with a voltage supply matched to its voltage rating (e.g. 12V). Thus, desired performance of the lower voltage rated motor (e.g. 5V) is achieved at less cost than a higher voltage rated motor (e.g. 12V) due to the lower amount of costly copper windings required in the lower voltage rated motor (e.g. 5V). In contrast, the control unit 300 supplies the motor supply voltage from the backup energy source 298 to the power release motor 9 without any voltage increase in response to the vehicle main power source 4 not being available.

Continuing to refer to FIG. 3, the latch assembly 1, 1′ further includes a power release motor bridge 304 connected to the power release motor 9 and the control unit 300 and configured to provide power to the power release motor 9. The latch assembly 1, 1′ may also include a power management unit 306 connected to the control unit 300 and configured to manage electrical power in the latch assembly 1, 1′. According to one aspect, the power management unit 306 can includes a low-dropout (LDO) 5V regulator to be able to receive either the 9-16V battery supply Vbattery or a lower 7.5 V supercapacitor supply (i.e., motor supply voltage) of supercapacitor unit 320, described below, and regulate the voltage output to 5V for the control unit 300 and other circuits. The latch assembly 1, 1′ can further include a bus transceiver unit 308 connected to the control unit 300 and configured to enable communication therebetween (or with other controllers via a communication bus).

According to further aspects of the disclosure and still referring to FIG. 3, the latch assembly 1, 1′ can also include a battery input unit 316 connected to the vehicle main power source 4 of the motor vehicle 3 and configured to receive a battery voltage. A reverse protection unit 318 is connected to battery input unit 316 and configured to protect the latch assembly 1, 1′ from reversal of electrical polarity from the vehicle main power source 4. The backup energy source 298 of the latch assembly 1, 1′ can include a supercapacitor unit 320 comprising a plurality of supercapacitors (e.g., capacitors 64) and storing electrical energy from the vehicle main power source 4 for use by the latch assembly 1, 1′ when the vehicle main power source 4 is unavailable. The backup energy source 298, and for example supercapacitor unit 320, may have an output voltage rating that is matched, or approximately matched, or substantially matched, with the input voltage operating rating of the power release motor 9 such that the power release motor 9 can be directly driven by the backup energy source 298 (e.g. supercapacitor unit 320) without the need for use of a voltage step up converter, such as a boost converter or circuit, in order to increase the voltage level of the output of the backup energy source 298 to match the operating voltage of the motor 9. For example, supercapacitor unit 320 may include a series of two supercapacitors each rated at 2.5 Volts for providing a total voltage output of 5 V for supply of motor 9 also rated at 5 Volts. For example, supercapacitor unit 320 may include a single, or only one supercapacitor rated at 5 Volts for supply to a motor 9 also rated at 5 Volts. In other words, the operating ratings of the backup energy source 298 and the motor 9 are matched. Other voltage matching combinations of the backup energy source 298 with the power release motor 9 may be provided. In other possible configurations, there may be a mismatch between the voltage output of the backup energy source 298 with the power release motor 9. In one example, a single supercapacitor may be provided, having a voltage rating of 2.5V, while a 5V rated power release motor provided, with a further provided voltage step up converter to double the voltage output of the supercapacitor to match with the motor. With a lower voltage rated motor, a smaller, less costly voltage step up converter, may be provided. Therefore the voltage received by the power release motor bridge 304 at its input(s) during either the normal mode or the emergency mode are the same level.

Still referring to FIG. 3, notably, no boost converter, or DC to DC converter, is connected to the supercapacitor unit 320 to boost a first voltage (i.e., the battery voltage Vbattery) from the supercapacitor unit 320 to a second voltage (i.e., the motor supply voltage) used by the latch assembly 1, 1′. Since no boost is provided, an additional supercapacitor (e.g., 3 total) may be included in the supercapacitor unit 320 to raise the voltage to a level such that the motor 9 can be directly driven with (without requiring to increase the voltage of the supercapacitor unit 320 to the operating rating of the motor 9 e.g. without using a step-up voltage converter).

A supercapacitor switch 322 is connected to the supercapacitor unit 320 and configured to selectively couple the motor supply voltage from the supercapacitor unit 320 to the power release motor bridge 304 and the power management unit 306 during the emergency operating condition and while charging during the normal operating condition. The supercapacitor switch 322 selectively decouples the motor supply voltage from the supercapacitor unit 320 from the power release motor bridge 304 and the power management unit 306 while not charging during the normal operating condition. So, in the normal mode or operating condition, the supercapacitor switch 322 will automatically turn on during charging and turn off when supercapacitor unit 320 is charged, the supercapacitor switch 322 will turn off to not damage the supercapacitor unit 320. During the emergency mode or operating condition, the supercapacitor switch 322 will be turned on to power the circuit using the supercapacitor unit 320.

A backup enable unit 324 is connected to the supercapacitor unit 320 and to the supercapacitor switch 322 and the control unit 300 and is configured to control the supercapacitor switch 322. A power supply selector 326 is connected to the supercapacitor switch 322 and the reverse protection unit 318 and the power release motor bridge 304 and is configured to select between electrical power from the vehicle main power source 4 and the supercapacitor unit 320.

The latch assembly 1, 1′ also includes a supercapacitor management unit 328 connected to the control unit 300 and the supercapacitor unit 320 and the power supply selector 326 and configured to manage the supercapacitor unit 320. Because three supercapacitors may be used in the supercapacitor unit 320, load balancing by the supercapacitor management unit 328 may be adjusted to balance the three supercapacitors. A battery reading unit 330 is connected to and is configured to read a voltage of the vehicle main power source 4 and connected to the control unit 300. An internal handle reading unit 332 is connected to the backup enable unit 324 and the control unit 300 and the power management unit 306 and is configured to determine a state of internal handles (e.g., handle 16 in FIG. 1) disposed inside the motor vehicle 3 controlling the latch and unlatch of the closure panel 2. An external handle reading unit 334 is connected to the backup enable unit 324 and the control unit 300 and the power management unit 306 and is configured to determine a state of external handles (e.g., handle 16 in FIG. 1, shown in phantom lines) disposed on an outside of the motor vehicle 3 controlling the latch and unlatch of the closure panel 2. A hall sensor reading unit 336 is connected to the control unit 300 and the power management unit 306 and is configured to monitor the operation of the latch assembly 1, 1′. A crash line reading unit 338 is connected to the control unit 300 and the power management unit 306 and is configured to monitor a crash line (e.g., a communication line from the vehicle management unit 12 or another electronic control unit of the motor vehicle 3). A light emitting diode driver unit 340 is connected to the control unit 300 and the power management unit 306 and is configured to drive at least one light emitting diode.

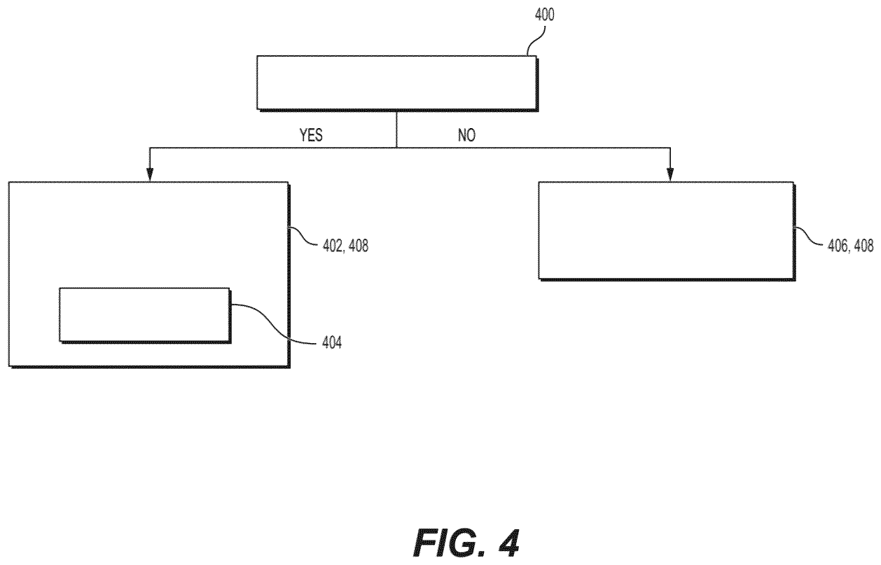

FIG. 4 illustrates steps of a method of operating the latch assembly 1, 1′ for the closure panel 2 of the motor vehicle 3. The method includes the step of 400 determining whether a vehicle main power source 4 is available. The method continues with the step of 402 reducing a battery voltage Vbattery from the vehicle main power source 4 to a motor supply voltage supplied to a power release motor 9 of an actuation group 6′ movable to latch and unlatch the closure panel 2 in response to the vehicle main power source 4 being available. According to an aspect, the step of 402 reducing the battery voltage from the vehicle main power source 4 to the motor supply voltage supplied to the power release motor 9 of the actuation group 6′ movable to latch and unlatch the closure panel 2 includes 404 controlling a pulse width modulation signal to the power release motor 9 (e.g., the driving signals Sd). The method additionally includes the step of 406 supplying the motor supply voltage from a backup energy source 298 coupled to the vehicle main power source 4 to the power release motor 9 without any voltage increase in response to the vehicle main power source 4 not being available (e.g. without the use of a step-up voltage converter). The method also includes the step of 408 controlling the actuation group 6′ to control latching and unlatching the closure panel 2.

According to other aspects of the disclosure, the method further includes the step of providing power to the power release motor 9 using a power release motor bridge 304 connected to the power release motor 9 and a control unit 300. The method additionally includes the step of moving a pawl 8 of the actuation group 6′ and allow a ratchet 6 of the actuation group 6′ to rotate and release a striker 7 attached to the motor vehicle 3 and selectively engaged by the ratchet 6 to latch and unlatch the closure panel 2 and the latch assembly 1, 1′ using the power release motor 9. In addition, the method includes the step of managing electrical power in the latch assembly 1, 1′ using a power management unit 306 connected to the control unit 300. The method also includes the step of enabling communication between the control unit 300 and bus transceiver unit 308 connected to the control unit 300.

In more detail and according to further aspects, the method includes the step of receiving a battery voltage Vbattery using a battery input unit 316 connected to the vehicle main power source 4 of the motor vehicle 3. The method additionally includes the step of storing electrical energy from the vehicle main power source 4 for use by the latch assembly 1, 1′ when the vehicle main power source 4 is unavailable using a supercapacitor unit 320 of the backup energy source 298. In addition, the method includes the step of selectively coupling the motor supply voltage from the supercapacitor unit 320 to the power release motor bridge 304 and the power management unit 306 during an emergency operating condition different than a normal operating condition and while charging during the normal operating condition and selectively decoupling the motor supply voltage from the supercapacitor unit 320 from the power release motor bridge 304 and the power management unit 306 while not charging during the normal operating condition using a supercapacitor switch 322 connected to the supercapacitor unit 320. Furthermore, the method includes the step of controlling the supercapacitor switch 322 using a backup enable unit 324 connected to the supercapacitor unit 320 and to the supercapacitor switch 322 and the control unit 300. The method also includes the step of selecting between electrical power from the vehicle main power source 4 and the supercapacitor unit 320 using a power supply selector 326 connected to the supercapacitor switch 322 and the power release motor bridge 304.

According to additional aspects, the method further includes reading a battery voltage Vbattery of the vehicle main power source 4 using a battery reading unit 330 connected thereto and connected to the control unit 300. The method additionally includes the step of determining a state of internal handles (e.g., handle 16 of FIG. 1) disposed inside the motor vehicle 3 controlling the latch and unlatch of the closure panel 2 using an internal handle reading unit 332 connected to the backup enable unit 324 and the control unit 300 and the power management unit 306. Also, the method includes the step of determining a state of external handles (e.g., handle 16 of FIG. 1, shown in phantom lines) disposed on an outside of the motor vehicle 3 controlling the latch and unlatch of the closure panel 2 using an external handle reading unit 334 connected to the backup enable unit 324 and the control unit 300 and the power management unit 306. The method further includes the step of monitoring operation of the latch assembly 1, 1′ using a hall sensor reading unit 336 connected to the control unit 300 and the power management unit 306. In addition, the method includes the step of monitoring a crash line using a crash line reading unit 338 connected to the control unit 300 and the power management unit 306. The method also includes the step of driving at least one light emitting diode using a light emitting diode driver unit 340 connected to the control unit 300 and the power management unit 306.

In addition and according to further aspects, the method also includes the step of protecting the latch assembly 1, 1′ from reversal of electrical polarity from the vehicle main power source 4 using a reverse protection unit 318 connected to battery input unit 316 and the power supply selector 326. The method also includes the step of managing the supercapacitor unit 320 using a supercapacitor management unit 328 connected to the control unit 300 and the supercapacitor unit 320 and the power supply selector 326.

Now referring to FIG. 5, there is illustrated in accordance with another exemplary embodiment a block diagram of an electronic control circuit 10′ of the latch assembly 1, 1′ for the closure panel 2 of the motor vehicle 3 shown in FIG. 1, now described with like elements and components associated with the other embodiments herein above, but referenced using numerals offset by a factor of prime “′” for convenience. The electronic control circuit 10′ includes a backup voltage supply circuit 295 having a backup energy source 298′ coupled to the vehicle main power source 4′ (e.g., vehicle battery) of the motor vehicle 3. The vehicle main power source 4′ is configured to provide a motor supply voltage at output 300′ (e.g., 9-16 Volts), and for example a voltage level of 12V. According to an aspect, the backup energy source 298′ is configured to provide the motor supply voltage during an emergency operating condition different than a normal operating condition and in which the vehicle main power source 4′ is not available. Backup energy source 298′ includes a backup energy source output 302′ electrically coupled to a supercapacitor switch 304′. Backup energy source output 302′ outputs stored energy within the backup energy source 298′ received during charging from vehicle main power source 4′ as a supercapacitor supply voltage, that is lower than the motor supply voltage of the output 300′. A supercapacitor switch 304′ is provided and is electrically coupled to the power release motor 9′ and to the output 302′. Supercapacitor switch 322′ is illustratively electrically coupled to the power release motor 9′ via an H-Bridge 304′. Backup energy source output 302′ is connected to H-Bridge 304′ when supercapacitor switch 322′ is in a closed state, or ON position, corresponding to an emergency state of the latch assembly 1, 1′, and is electrically disconnected from the H-Bridge 304′ when supercapacitor switch 322′ is in an open state, or OFF position, corresponding to a normal, non-emergency state of the latch assembly 1, 1′. As illustrated, there is no voltage stepup converter (e.g. a boost converter), provided between the backup energy source output 302′, when supercapacitor switch 322′ is in a closed state, or ON position, and the H-Bridge 304′ such that the H-Bridge 304′ will receive the direct voltage output of the backup energy source 298′. Without such a voltage step-up converter (e.g. a boost converter), cost of the electronic control circuit 10′ is reduced, printed circuit board layout and sizing is simplified and reduced, as well as power loss efficiency is improved. H-Bridge 304′ there receives the same voltage (e.g. 5V with reference to FIG. 5, or 12V with reference to FIG. 5A, as examples) from the normal voltage supply circuit 293 and the backup voltage supply circuit 295.

Still referring to FIG. 5, backup energy source 298′ is coupled to the vehicle main power source 4′ via a charging configuration such as a circuit, device or element, which is illustratively shown to include a step down voltage converter, or for example a buck converter 299, e.g. a DC to DC converter. Buck converter 299 is coupled at its an input 301 to output 300′ of vehicle main power source 4′ and at its output 297 to backup energy source 298′ for charging the backup energy source 298′ when the vehicle main power source 4′ is available, for example during a normal operating condition of the latch assembly 1, 1′. Buck converter 299 is configured to reduce, or drop, the voltage supplied by the vehicle main power source 4′ e.g. (reduced from 12V to 5V) to supply a charging supply voltage at output 297 to charge the backup energy source 298′ to the supercapacitor supply voltage for output at the backup energy source output 302′.

Still referring to FIG. 5, vehicle main power source 4′ is coupled to supply the power release motor 9′ with power during the normal non-emergency mode of the latch assembly 1, 1′. The motor supply voltage at output 300′ is not directly supplied to the power release motor 9′ due to the mismatched voltage rating of the power release motor 9′ and the voltage supply level which would lead to an improper operation of the power release motor 9′. For example, a direct supply of voltage from the vehicle main power source 4′ during a normal operating mode would cause the power release motor 9′ to excessively rotate at an incorrect speed for moving the pawl 8 which may cause improper activation of the pawl 8 leading to increase release noise, or damage to the power release motor 9′ or a kinematic chain provided between the motor 9′ and the pawl 8.

Sill referring to FIG. 5, a normal voltage supply circuit 293 having a switch 303 (e.g. a FET or MOSFET as non-limiting examples) is provided electrically connected to the motor 9′ and to the vehicle main power source 4′. Switch 303 may be controlled by a switching method, such as pulse width modulation (“PWM”) whereby the switch 303 is switched ON and OFF according to a duty cycle to provide a reduction (e.g. with switch 303 operated at a 50% duty cycle to provide less than 100% of vehicle main power source 4′ power delivery) in average power delivered to the motor 9′ as compared to a full supply of power delivered through a direct connection of the motor 9′ with the (e.g. a 100% supply), to the vehicle main power source 4. Switch 303 may be operated e.g. turned ON and OFF using a duty cycle that reduces the voltage supplied to the motor 9′ to cause matching of voltage with the operating voltage rating of the motor, and therefore for example a reduction in the speed of operation of the motor 9. For example, switch 303 may be operated to reduce an average power supplied to the motor 9′, by supplying the motor 9′ with a modulated signal e.g. a modulated power supply signal. Normal voltage supply circuit 293 is therefore configured to supply a converted voltage supply of the main power source 4′ to the power release motor 9′. For example, normal voltage supply circuit 293 is therefore configured to supply a down converted voltage supply, or reduced voltage supply, of the main power source 4′ to the power release motor 9′ As a result, a reduction to the voltage of the vehicle main power source 4′ at the switch input 307 results compared to the switch output 305 in order to match the motor 9′ operating voltage at the switch output 305 and the vehicle main power source 4′ while the latch assembly 1, 1′ is in the normal operating mode, or non-emergency mode. The motor 9′ can be properly operated (e.g. correct rotation speed) despite using an improper voltage supply source e.g. a higher voltage vehicle main power source 4′.

Still referring to FIG. 5, a controller 310′ is provided and is configured to control the operation of the supercapacitor switch 322′, the switch 303, as well as the H-Bridge 304′. During normal mode of the latch assembly 1, 1′, controller 310′ may be configured to cycle the operation of the switch 303 (e.g. between ON and OFF) to provide an appropriately matched voltage for proper operation of the motor 9′. During emergency mode of the latch assembly 1, 1′, controller 310′ may be configured to set the state of the switch 303 to and OFF condition. During normal mode of the latch assembly 1, 1′, controller 310′ may be configured to turn the supercapacitor switch 322′ to an OFF position to prevent voltage supply to the H-Bridge 304′ from the backup energy source 298′. Controller 310′ may also be configured to receive a reduced voltage from the step-down voltage converter 299 (e.g. 5V) for its operation. Controller 310′ may also optionally be configured to enable or disable the step-down voltage converter 299. Controller 310′ may also be configured to control the direction of the H-bridge 304′ polarity for driving the power release motor 9′ in a power releasing direction, or in an opposite reset direction.

In another possible configuration and referring to FIG. 5A, an electronic control circuit 10″ of the latch assembly 1, 1′ for the closure panel 2 of the motor vehicle 3 shown in FIG. 1 is provided. For example, motor vehicle may be in one possible configuration and BEV or Battery Operated Vehicle, or HEV or Hybrid Operated Vehicle having a 48V voltage bus off of a high-voltage battery 4″ used for driving the electric propulsion motors connected to the tire of the vehicle 3. The latch assembly 1, 1′ may be adapted using the electronic control circuit 10″ to operate off of the higher voltage propulsion battery e.g. 48V when an separate 12 V is not provided. In Similar manners as described above, switch 303 may be operated to match the supply voltage of 48V at output 300′ with the motor 9″ operating voltage of 12V. Thus the power release motor 9″ may be operated using power from the high-voltage battery 4″ when no 12V battery is provided in the vehicle 3 that is reduced to match the operating voltage of the power 9″. Step down converter 299″ may be configured to step the voltage of the 48V high-voltage battery 4″ to match with the operating rating of the backup energy source 298″ e.g. 12V. As a result, no step-up converter is provided between the backup energy source 298″ and the motor 9″ as the voltage ratings are matched (e.g. 12 Volts).

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

What is claimed is:

1. A latch assembly for a closure panel of a motor vehicle, comprising:
a backup energy source coupled to a vehicle main power source of the motor vehicle and configured to provide a motor supply voltage;
an actuation group having a power release motor being movable to latch and unlatch the closure panel; and
a control unit coupled to the actuation group and configured to:
determine whether the vehicle main power source is available,
reduce a battery voltage from the vehicle main power source to the motor supply voltage supplied to the power release motor in response to the vehicle main power source being available, and
supply the motor supply voltage from the backup energy source to the power release motor without any voltage increase in response to the vehicle main power source not being available.

2. The latch assembly as set forth in claim 1, wherein the reducing the battery voltage from the vehicle main power source to the motor supply voltage supplied to the power release motor of the actuation group includes controlling a switch to supply a modulated signal to the power release motor to reduce an average power supplied to the power release motor.

3. The latch assembly as set forth in claim 1, wherein the power release motor is configured to move at least two pawls of the actuation group to allow a ratchet of the actuation group to rotate and release a striker attached to the motor vehicle and to selectively engaged by the ratchet to latch and unlatch the closure panel.

4. The latch assembly as set forth in claim 3, wherein the backup energy source includes a supercapacitor unit storing electrical energy from the vehicle main power source for use by the latch assembly when the vehicle main power source is unavailable, wherein the supercapacitor unit has a voltage rating that substantially matches the voltage rating of the power release motor.

5. The latch assembly as set forth in claim 4, further including a voltage step down converter connected to the vehicle main power source and to the supercapacitor unit, the voltage step down conversion converter configured to reduce the battery voltage from the vehicle main power source supplied to the supercapacitor unit for charging the supercapacitor unit to a supercapacitor supply voltage in response to the vehicle main power source being available.

6. The latch assembly as set forth in claim 1, wherein the latch assembly is provided without a voltage step-up converter to increase the motor supply voltage from the backup energy source to supply the power release motor during the vehicle main power source not being available.

7. The latch assembly as set forth in claim 1, wherein the power release motor is operable with the motor supply voltage from the backup energy source directly during an emergency operating condition different than a normal operating condition and in which the vehicle main power source is not available and wherein the motor supply voltage is less than the battery voltage of the vehicle main power source output during the normal operating condition in which the vehicle main power source is available.

8. The latch assembly as set forth in claim 1, wherein the battery voltage from the vehicle main power source is within a range of approximately 9 volts to 16 volts and the motor supply voltage from the backup energy source is within a range of approximately 3.5 volts to 7.5 volts, and the operating voltage of the power release motor is within a range of approximately 3.5 volts to 7.5 volts.

9. A method of operating a latch assembly for a closure panel of a motor vehicle, the method comprising:
determining whether a vehicle main power source is available;
reducing a battery voltage from the vehicle main power source to a motor supply voltage supplied to a power release motor of an actuation group movable to latch and unlatch the closure panel in response to the vehicle main power source being available;
supplying the motor supply voltage from a backup energy source coupled to the vehicle main power source to the power release motor without any voltage increase in response to the vehicle main power source not being available; and
controlling the actuation group to control latching and unlatching the closure panel.

10. The method as set forth in claim 9, wherein the step of reducing the battery voltage from the vehicle main power source to the motor supply voltage supplied to the power release motor of the actuation group includes controlling a modulated signal to the power release motor.

11. The method as set forth in claim 10, further including the steps of:
providing a switch connected to the vehicle main power source;
providing a power release motor bridge connected to the power release motor and to the switch;
using a control unit to turn the switch on and off to control the modulated signal; and
moving at least two pawls of the actuation group and allow a ratchet of the actuation group to rotate and release a striker attached to the motor vehicle and selectively engaged by the ratchet to latch and unlatch the closure panel and the latch assembly using the power release motor.

12. The method as set forth in claim 11, further including the steps of:
using a buck converter coupled to the vehicle main power source and to the backup energy source, the buck converter for reducing the battery voltage from the vehicle main power source to a charging supply voltage supplied to the backup energy source during the vehicle main power source being available.

13. The method as set forth in claim 9, further including:
not using a boost converter for increasing the motor supply voltage from the backup energy source supplied to the power release motor during the vehicle main power source not being available.

14. The method as set forth in claim 13, further including:
using a supercapacitor unit as the backup energy source, wherein the supercapacitor unit has a voltage rating that matches the voltage rating of the power release motor.

15. A latch assembly for a closure panel of a motor vehicle, comprising:
a backup energy source coupled to a vehicle main power source of the motor vehicle and configured to provide a motor supply voltage;
an actuation group having a power release motor being movable to latch and unlatch the closure panel;
a normal voltage supply circuit for coupling the vehicle main power source to the power release motor during a normal operating condition, wherein the normal voltage supply circuit is configured to convert a voltage of the vehicle main power source to match the operating rating of the power release motor; and
a backup voltage supply circuit for coupling the backup energy source to the power release motor during an emergency operating condition, wherein the backup voltage supply circuit is configured not to convert the motor supply voltage to the power release motor.

16. The latch assembly as set forth in claim 15, wherein the power release motor is configured to use the motor supply voltage supplied from the backup energy source without the motor supply voltage being increased with the use of a boost convertor.

17. The latch assembly as set forth in claim 15, wherein the power release motor is configured to receive a down converted motor supply voltage supplied from the vehicle main power source.

18. The latch assembly as set forth in claim 15, further including a control unit and wherein the power release motor is configured to move at least one pawl of the actuation group and allow a ratchet of the actuation group to rotate and release a striker attached to the motor vehicle and selectively engaged by the ratchet to latch and unlatch the closure panel and the latch assembly further includes:
a power release motor bridge connected to the power release motor and the control unit and configured to provide power to the power release motor; and
a switch connected to the power release motor bridge and to the vehicle main power source, wherein the switch is turned on and off to reduce the average power supplied from the vehicle main power source to the power release motor bridge.

19. The latch assembly as set forth in claim 18, wherein the at least one pawl includes at least two pawls.

20. The latch assembly as set forth in claim 15, further including:
a buck converter coupled to the vehicle main power source and to the backup energy source, wherein the buck converter is configured to reduce the battery voltage from the vehicle main power source to a charging supply voltage supplied to the backup energy source during the vehicle main power source being available.
